(19) United States
(12) Patent Application Publication
(10) Pub. No.: US 2010/0174868 A1
(43) Pub. Date: Jul. 8, 2010

(54) Processor device having a sequential data processing unit and an arrangement of data processing elements

(76) Inventor: Martin Vorbach, Munich (DE)

Correspondence Address: KENYON & KENYON LLP, ONE BROADWAY, NEW YORK, NY, 10004, US

(21) Appl. No.: 12/729,090

(22) Filed: Mar. 22, 2010

Related U.S. Application Data
(63) Continuation of application No. 10/508,559, filed on Jun. 20, 2005.

(30) Foreign Application Priority Data
Mar. 21, 2002 (DE) 102 12 621.6
Mar. 21, 2002 (DE) 102 12 622.4
May 2, 2002 (DE) 102 19 681.8
May 2, 2002 (EP) 02 009 868.7
Jun. 12, 2002 (DE) 102 26 186.5
Jun. 20, 2002 (DE) 102 27 650.1
Jun. 20, 2002 (EP) PCT/EP02/06865
Aug. 7, 2002 (DE) 102 36 269.6
Aug. 7, 2002 (DE) 102 36 271.8
Aug. 7, 2002 (DE) 102 36 272.6
Aug. 16, 2002 (EP) PCT/EP02/10065
Aug. 21, 2002 (DE) 102 38 172.0
Aug. 21, 2002 (DE) 102 38 173.9
Aug. 21, 2002 (DE) 102 38 174.7
Aug. 27, 2002 (DE) 102 40 000.8
Aug. 27, 2002 (DE) 102 40 022.9
Sep. 3, 2002 (DE) PCT/DE02/03278
Sep. 6, 2002 (DE) 102 41 812.8
Sep. 18, 2002 (EP) PCT/EP02/10464
Sep. 18, 2002 (EP) PCT/EP02/10479
Sep. 19, 2002 (EP) PCT/EP02/10572
Sep. 19, 2002 (EP) PCT/EP02/10572
Oct. 10, 2002 (EP) 02 022 692.4
Dec. 6, 2002 (EP) 02 027 277.9
Jan. 7, 2003 (DE) 103 00 380.0
Jan. 20, 2003 (DE) PCT/DE03/00152
Jan. 20, 2003 (EP) PCT/EP03/00624
Feb. 18, 2003 (DE) PCT/DE03/00489

(51) Int. Cl. G06F 12/08; G06F 9/02; G06F 15/80

(52) U.S. Cl. 711/130; 711/E12.017; 712/10; 712/E09.002

(57) ABSTRACT

Designing a coupling of a traditional processor, in particular a sequential processor, and a reconfigurable field of data processing units, in particular a runtime-reconfigurable field of data processing units is described.

### FIELD OF THE INVENTION

The present invention relates to the integration and/or snug coupling of reconfigurable processors with standard processors, data exchange and synchronization of data processing as well as compilers for them.

### BACKGROUND INFORMATION

A reconfigurable architecture in the present context is understood to refer to modules or units (VPUs) having a configurable function and/or interconnection, in particular integrated modules having a plurality of arithmetic and/or logic and/or analog and/or memory and/or internal/external interconnecting modules in one or more dimensions interconnected directly or via a bus system.

Conventional types of such modules includes, for example, systolic arrays, neural networks, multiprocessor systems, processors having a plurality of arithmetic units and/or logic cells and/or communicative/peripheral cells (IO), interconnection and network modules such as crossbar switches, and conventional modules of FPGA, DPGA, Chameleon, XPUTER, etc. Reference is made in this connection to the following patents and patent applications: P 44 16 881 A1, DE 197 81 412 A1, DE 197 81 483 A1, DE 196 54 846 A1, DE 196 54 593 A1, DE 197 04 044.6 A1, DE 198 80 129 A1, DE 198 61 088 A1, DE 199 80 312 A1, PCT/DE 00/01869, DE 100 36 627 A1, DE 100 28 397 A1, DE 101 10 530 A1, DE 101 11 014 A1, PCT/EP 00/10516, EP 01 102 674 A1, DE 198 80 128 A1, DE 101 39 170 A1, DE 198 09 640 A1, DE 199 26 538.0 A1, DE 100 50 442 A1, PCT/EP 02/02398, DE 102 40 000, DE 102 02 044, DE 102 02 175, DE 101 29 237, DE 101 42 904, DE 101 35 210, EP 01 129 923, PCT/EP 02/10084, DE 102 12 622, DE 102 36 271, DE 102 12 621, EP 02 009 868, DE 102 36 272, DE 102 41 812, DE 102 36 269, DE 102 43 322, EP 02 022 692, DE 103 00 380, DE 103 10 195 and EP 02 001 331 and EP 02 027 277. The full content of these documents is herewith incorporated for disclosure purposes.

The architecture mentioned above is used as an example for clarification and is referred to below as a VPU. This architecture is composed of any, typically coarsely granular arithmetic, logic cells (including memories) and/or memory cells and/or interconnection cells and/or communicative/peripheral (IO) cells (PAEs) which may be arranged in a one-dimensional or multi-dimensional matrix (PA). The matrix may have different cells of any design; the bus systems are also understood to be cells here. A configuration unit (CT) which stipulates the interconnection and function of the PA through configuration is assigned to the matrix as a whole or parts thereof. A finely granular control logic may be provided.

Various methods are known for coupling reconfigurable processors with standard processors. They usually involve a loose coupling. In many regards, the type and manner of coupling still need further improvement; the same is true for compiler methods and/or operating methods provided for joint execution of programs on combinations of reconfigurable processors and standard processors.

### SUMMARY

An object of the present invention is to provide a novel approach for commercial use.

A standard processor, e.g., an RISC, CISC, DSP (CPU), may be connected to a reconfigurable processor (VPU). Described are two different embodiments of couplings. In one embodiment, the two described embodiments may be simultaneously implemented.

In one embodiment of the present invention, a direct coupling to the instruction set of a CPU (instruction set coupling) may be provided.

In a second embodiment of the present invention, a coupling via tables in the main memory may be provided.

These two embodiments may be simultaneously and/or alternatively implementable.

### BRIEF DESCRIPTION OF THE DRAWINGS

FIG. 1 is a diagram that illustrates components of an example system according to which a method of an example embodiment of the present invention may be implemented.

FIG. 2 is a diagram that illustrates an example interlinked list that may point to a plurality of tables in an order in which they were created or called, according to an example embodiment of the present invention.

FIG. 3 is a diagram that illustrates an example internal structure of a microprocessor or microcontroller, according to an example embodiment of the present invention.

FIG. 4 is a diagram that illustrates an example load/store unit, according to an example embodiment of the present invention.

FIG. 5 is a diagram that illustrates example couplings of a VPU to an external memory and/or main memory via a cache, according to an example embodiment of the present invention.

FIG. 5a is a diagram that illustrates example couplings of RAM-PAEs to a cache via a multiplexer, according to an example embodiment of the present invention.

FIG. 5b is a diagram that illustrates a system in which there is an implementation of one bus connection to cache, according to an example embodiment of the present invention.

FIG. 6 is a diagram that illustrates a coupling of an FPGA structure to a data path considering an example of a VPU architecture, according to an example embodiment of the present invention.

FIGS. 7a-7c illustrate example groups of PAEs of one or more VPUs for application of example methods, according to example embodiments of the present invention.

### DETAILED DESCRIPTION

### Instruction Set Coupling

Free unused instructions may be available within an instruction set (ISA) of a CPU. One or a plurality of these free unused instructions may be used for controlling VPUs (VPUCODE).

By decoding a VPUCODE, a configuration unit (CT) of a VPU may be triggered, executing certain sequences as a function of the VPUCODE.

For example, a VPUCODE may trigger the loading and/or execution of configurations by the configuration unit (CT) for a VPU.

### Command Transfer to the VPU

In an one embodiment, a VPUCODE may be translated into various VPU commands via an address mapping table, e.g., which may be constructed by the CPU. The configuration table may be set as a function of the CPU program or code segment executed.

After the arrival of a load command, the VPU may load configurations from a separate memory or a memory shared with the CPU, for example. In particular, a configuration may be contained in the code of the program currently being executed.

After receiving an execution command, a VPU may execute the configuration to be executed and will perform the corresponding data processing. The termination of data processing may be displayed on the CPU by a termination signal (TERM).

### VPUCODE Processing on the CPU

When a VPUCODE occurs, wait cycles may be executed on the CPU until the termination signal (TERM) for termination of data processing by the VPU arrives.

In one example embodiment, processing may be continued by processing the next code. If there is another VPUCODE, processing may then wait for the termination of the preceding code, or all VPUCODEs started may be queued into a processing pipeline, or a task change may be executed as described below.

Termination of data processing may be signaled by the arrival of the termination signal (TERM) in a status register. The termination signals may arrive in the sequence of a possible processing pipeline. Data processing on the CPU may be synchronized by checking the status register for the arrival of a termination signal.

In one example embodiment, if an application cannot be continued before the arrival of TERM, e.g., due to data dependencies, a task change may be triggered.

### Coupling of Coprocessors (Loose Coupling)

According to DE 101 10 530, loose couplings, in which the VPUs work largely as independent coprocessors, may be established between processors and VPUs.

Such a coupling typically involves one or more common data sources and data sinks, e.g., via common bus systems and/or shared memories. Data may be exchanged between a CPU and a VPU via DMAs and/or other memory access controllers. Data processing may be synchronized, e.g., via an interrupt control or a status query mechanism (e.g., polling).

### Coupling of Arithmetic Units (Snug Coupling)

A snug coupling may correspond to a direct coupling of a VPU into the instruction set of a CPU as described above.

In a direct coupling of an arithmetic unit, a high reconfiguration performance may be of import. Therefore the wave reconfiguration according to DE 198 07 872, DE 199 26 538, DE 100 28 397 may be used. In addition, the configuration words may be preloaded in advance according to DE 196 54 846, DE 199 26 538, DE 100 28 397, DE 102 12 621 so that on execution of the instruction, the configuration may be configured particularly rapidly (e.g., by wave reconfiguration in the optimum case within one clock pulse).

For the wave reconfiguration, the presumed configurations to be executed may be recognized in advance, i.e., estimated and/or predicted, by the compiler at the compile time and preloaded accordingly at the runtime as far as possible. Possible methods are described, for example, in DE 196 54 846, DE 197 04 728, DE 198 07 872, DE 199 26 538, DE 100 28 397, DE 102 12 621.

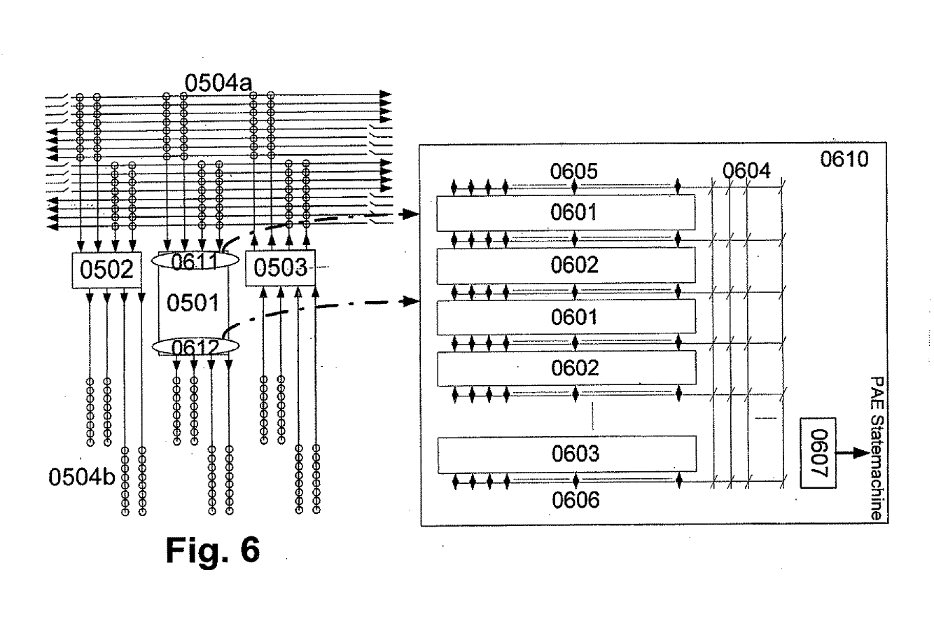

At the point in time of execution of the instruction, the configuration or a corresponding configuration may be selected and executed. Such methods are known according to the publications cited above. Configurations may be preloaded into shadow configuration registers, as is known, for example, from DE 197 04 728 (FIG. 6) and DE 102 12 621 (FIG. 14) in order to then be available particularly rapidly on retrieval.

### Data Transfers

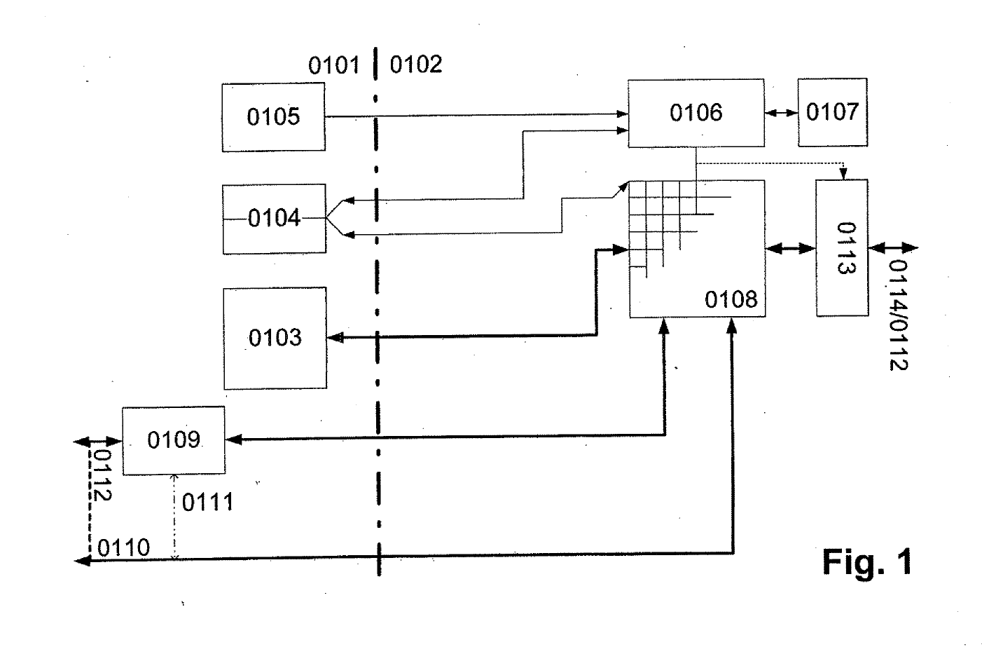

One possible embodiment of the present invention, e.g., as shown in FIG. 1, may involve different data transfers between a CPU (0101) and VPU (0102). Configurations to be executed on the VPU may be selected by the instruction decoder (0105) of the CPU, which may recognize certain instructions intended for the VPU and trigger the CT (0106) so the CT loads into the array of PAEs (PA, 0108) the corresponding configurations from a memory (0107) which may be assigned to the CT and may be, for example, shared with the CPU or the same as the working memory of the CPU.

It should be pointed out explicitly that for reasons of simplicity, only the relevant components (in particular the CPU) are shown in FIG. 1, but a substantial number of other components and networks may be present.

Three methods that may be used, e.g., individually or in combination, are described below.

### Registers

In a register coupling, the VPU may obtain data from a CPU register (0103), process it and write it back to a CPU register or the CPU register.

Synchronization mechanisms may be used between the CPU and the VPU.

For example, the VPU may receive an RDY signal (DE 196 51 075, DE 110 10 530) due to the fact that data is written into a CPU register by the CPU and then the data written in may be processed. Readout of data from a CPU register by the CPU may generate an ACK signal (DE 196 51 075, DE 110 10 530), so that data retrieval by the CPU is signaled to the VPU. CPUs typically do not provide any corresponding mechanisms.

Two possible approaches are described in greater detail here.

One approach is to have data synchronization performed via a status register (0104). For example, the VPU may display in the status register successful readout of data from a register and the ACK signal associated with it (DE 196 51 075, DE 110 10 530) and/or writing of data into a register and the associated RDY signal (DE 196 51 075, DE 110 10 530). The CPU may first check the status register and may execute waiting loops or task changes, for example, until the RDY or ACK signal has arrived, depending on the operation. Then the CPU may execute the particular register data transfer.

In one embodiment, the instruction set of the CPU may be expanded by load/store instructions having an integrated status query (load_rdy, store_ack). For example, for a store_ack, a new data word may be written into a CPU register only when the register has previously been read out by the CPU and an ACK has arrived. Accordingly, load_rdy may read data out of a CPU register only when the VPU has previously written in new data and generated an RDY.

Data belonging to a configuration to be executed may be written into or read out of the CPU registers successively, more or less through block moves according to the related art. Block move instructions implemented, if necessary, may be expanded through the integrated RDY/ACK status query described above.

In an additional or alternative embodiment, data processing within the VPUs connected to the CPU may require exactly the same number of clock pulses as does data processing in the computation pipeline of the CPU. This concept may be used ideally in modern high-performance CPUs having a plurality of pipeline stages (>20) in particular. An advantage may be that no special synchronization mechanisms such as RDY/ACK are necessary. In this procedure, it may only be required that the compiler ensure that the VPU maintains the required number of clock pulses and, if necessary, balance out the data processing, e.g., by inserting delay stages such as registers and/or the fall-through FIFOs known from DE 110 10 530, FIGS. 9-10.

Another example embodiment permits a different runtime characteristic between the data path of the CPU and the VPU. To do so, the compiler may first re-sort the data accesses to achieve at least essentially maximal independence between the accesses through the data path of the CPU and the VPU. The maximum distance thus defines the maximum runtime difference between the CPU data path and the VPU. In other words, for example through a reordering method such as that known from the related art, the runtime difference between the CPU data path and the VPU data path may be equalized. If the runtime difference is too great to be compensated by re-sorting the data accesses, then NOP cycles (i.e., cycles in which the CPU data path is not processing any data) may be inserted by the compiler and/or wait cycles may be generated in the CPU data path by the hardware until the required data has been written from the VPU into the register. The registers may therefore be provided with an additional bit which indicates the presence of valid data.

It will appreciated that a variety of modifications and of different embodiments of these methods are possible.

The wave reconfiguration mentioned above, e.g., preloading of configurations into shadow configuration registers, may allow successive starting of a new VPU instruction and the corresponding configuration as soon as the operands of the preceding VPU instruction have been removed from the CPU registers. The operands for the new instruction may be written to the CPU registers immediately after the start of the instruction. According to the wave reconfiguration method, the VPU may be reconfigured successively for the new VPU instruction on completion of data processing of the previous VPU instruction and the new operands may be processed.

### Bus Accesses

In addition, data may be exchanged between a VPU and a CPU via suitable bus accesses on common resources.

### Cache

If there is to be an exchange of data that has been processed recently by the CPU and that may therefore still be in the cache (0109) of the CPU and/or may be processed immediately thereafter by the CPU and therefore would logically still be in the cache of the CPU, it may be read out of the cache of the CPU and/or written into the cache of the CPU preferably by the VPU. This may be ascertained by the compiler largely in advance of the compile time of the application through suitable analyses, and the binary code may be generated accordingly.

### Bus

If there is to be an exchange of data that is presumably not in the cache of the CPU and/or will presumably not be needed subsequently in the cache of the CPU, this data may be read directly from the external bus (0110) and the associated data source (e.g., memory, peripherals) and/or written to the external bus and the associated data sink (e.g., memory, peripherals), e.g., preferably by the VPU. This bus may be, e.g., the same as the external bus of the CPU (0112 and dashed line). This may be ascertained by the compiler largely in advance of the compile time of the application through suitable analyses, and the binary code may be generated accordingly.

In a transfer over the bus, bypassing the cache, a protocol (0111) may be implemented between the cache and the bus, ensuring correct contents of the cache. For example, the MESI protocol from the related art may be used for this purpose.

### Cache/RAM-PAE Coupling

In one example embodiment, a method may be implemented to have a snug coupling of RAM-PAEs to the cache of the CPU. Data may thus be transferred rapidly and efficiently between the memory databus and/or IO databus and the VPU. The external data transfer may be largely performed automatically by the cache controller.

This method may allow rapid and uncomplicated data exchange in task change procedures in particular, for realtime applications and multithreading CPUs with a change of threads.

Two example methods are described below:

### a) RAM-PAE/Cache Coupling

The RAM-PAE may transmit data, e.g., for reading and/or writing of external data, e.g., main memory data, directly to and/or from the cache. In one embodiment, a separate databus may be used according to DE 196 54 595 and DE 199 26 538. Then, independently of data processing within the VPU and, for example, via automatic control, e.g., by independent address generators, data may then be transferred to or from the cache via this separate databus.

### b) RAM-PAE as a Cache Slice

In one example embodiment, the RAM-PAEs may be provided without any internal memory but may be instead coupled directly to blocks (slices) of the cache. In other words, the RAM-PAEs may be provided with, e.g., only the bus triggers for the local buses plus optional state machines and/or optional address generators, but the memory may be within a cache memory bank to which the RAM-PAE may have direct access. Each RAM-PAE may have its own slice within the cache and may access the cache and/or its own slice independently and, e.g., simultaneously with the other RAM-PAEs and/or the CPU. This may be implemented by constructing the cache of multiple independent banks (slices).

If the content of a cache slice has been modified by the VPU, it may be marked as “dirty,” whereupon the cache controller may automatically write this back to the external memory and/or main memory.

For many applications, a write-through strategy may additionally be implemented or selected. In this strategy, data newly written by the VPU into the RAM-PAEs may be directly written back to the external memory and/or main memory with each write operation. This may additionally eliminate the need for labeling data as “dirty” and writing it back to the external memory and/or main memory with a task change and/or thread change.

In both cases, it may be expedient to block certain cache regions for access by the CPU for the RAM-PAE/cache coupling.

An FPGA (0113) may be coupled to the architecture described here, e.g., directly to the VPU, to permit finely granular data processing and/or a flexible adaptable interface (0114) (e.g., various serial interfaces (V24, USB, etc.), various parallel interfaces, hard drive interfaces, Ethernet, telecommunications interfaces (a/b, T0, ISDN, DSL, etc.)) to other modules and/or the external bus system (0112). The FPGA may be configured from the VPU architecture, e.g., by the CT, and/or by the CPU. The FPGA may be operated statically, i.e., without reconfiguration at runtime and/or dynamically, i.e., with reconfiguration at runtime.

### FPGAs in ALUs

FPGA elements may be included in a “processor-oriented” embodiment within an ALU-PAE. To do so, an FPGA data path may be coupled in parallel to the ALU or in a preferred embodiment, connected upstream or downstream from the ALU.

Within algorithms written in the high-level languages such as C, bit-oriented operations usually occur very sporadically and are not particularly complex. Therefore, an FPGA structure of a few rows of logic elements, each interlinked by a row of wiring troughs, may be sufficient. Such a structure may be easily and inexpensively programmably linked to the ALU. One essential advantage of the programming methods described below may be that the runtime is limited by the FPGA structure, so that the runtime characteristic of the ALU is not affected. Registers need only be allowed for storage of data for them to be included as operands in the processing cycle taking place in the next clock pulse.

In one example embodiment, additional configurable registers may be optionally implemented to establish a sequential characteristic of the function through pipelining, for example. This may be advantageous, for example when feedback occurs in the code for the FPGA structure. The compiler may then map this by activation of such registers per configuration and may thus correctly map sequential code. The state machine of the PAE which controls its processing may be notified of the number of registers added per configuration so that it may coordinate its control, e.g., also the PAE-external data transfer, to the increased latency time

An FPGA structure which may be automatically switched to neutral in the absence of configuration, e.g., after a reset, i.e., passing the input data through without any modification, may be provided. Thus if FPGA structures are not used, configuration data to set them may be omitted, thus eliminating configuration time and configuration data space in the configuration memories.

### Operating System Mechanisms

It may be that the methods described here do not at first provide any particular mechanism for operating system support. In other words, it may be desirable to ensure that an operating system to be executed behaves according to the status of a VPU to be supported. Schedulers may be required.

In a snug arithmetic unit coupling, it may be desirable to query the status register of the CPU into which the coupled VPU has entered its data processing status (termination signal). If additional data processing is to be transferred to the VPU, and if the VPU has not yet terminated the prior data processing, the system may wait or a task change may be implemented.

Sequence control of a VPU may essentially be performed directly by a program executed on the CPU, representing more or less the main program which may swap out certain subprograms with the VPU.

For a coprocessor coupling, mechanisms which may be controlled by the operating system, e.g., the scheduler, may be used, whereby the sequence control of a VPU may essentially be performed directly by a program executed on the CPU, representing more or less the main program which may swap out certain subprograms with the VPU.

After transfer of a function to a VPU, a scheduler
1. may have the current main program continue to run on the CPU if it is able to run independently and in parallel with the data processing on a VPU;
2. if or as soon as the main program must wait for the end of data processing on the VPU, the task scheduler may switch to a different task (e.g., another main program). The VPU may continue processing in the background regardless of the current CPU task.

It may be required of each newly activated task to check before use (if it uses the VPU) to determine whether the VPU is available for data processing or is still currently processing data. In the latter case, it may be required of the newly created task to wait for the end of data processing or a task change may be implemented.

An efficient method may be based on descriptor tables, which may be implemented as follows, for example:

On calling the VPU, each task may generate one or more tables (VPUPROC) having a suitable defined data format in the memory area assigned to it. This table may includes all the control information for a VPU such as the program/configuration(s) to be executed (or the pointer(s) to the corresponding memory locations) and/or memory location(s) (or the pointer(s) thereto) and/or data sources (or the pointer(s) thereto) of the input data and/or the memory location(s) (or the pointer(s) thereto) of the operands or the result data.

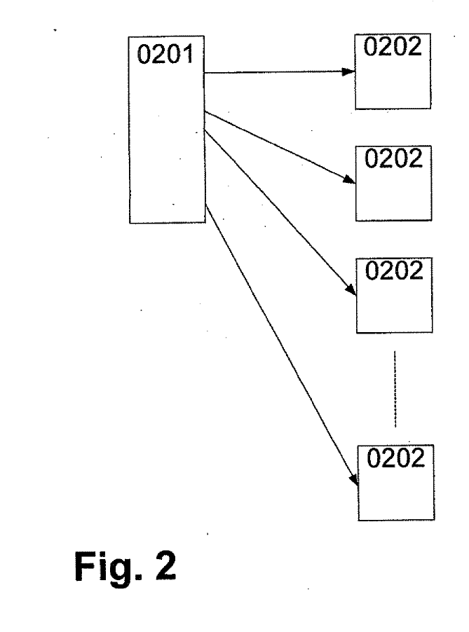

According to FIG. 2, a table or an interlinked list (LINKLIST, 0201), for example, in the memory area of the operating system may point to all VPUPROC tables (0202) in the order in which they are created and/or called.

Data processing on the VPU may now proceed by a main program creating a VPUPROC and calling the VPU via the operating system. The operating system may then create an entry in the LINKLIST. The VPU may process the LINKLIST and execute the VPUPROC referenced. The end of a particular data processing run may be indicated through a corresponding entry into the LINKLIST and/or VPUCALL table. Alternatively, interrupts from the VPU to the CPU may also be used as an indication and also for exchanging the VPU status, if necessary.

In this method, the VPU may functions largely independently of the CPU. In particular, the CPU and the VPU may perform independent and different tasks per unit of time. It may be required only that the operating system and/or the particular task monitor the tables (LINKLIST and/or VPUPROC).

Alternatively, the LINKLIST may also be omitted by interlinking the VPUPROCs together by pointers as is known from lists, for example. Processed VPUPROCs may be removed from the list and new ones may be inserted into the list. This is conventional method, and further explanation thereof is therefore not required for an understanding of the present invention.

### Multithreading/Hyperthreading

In one example embodiment, multithreading and/or hyperthreading technologies may be used in which a scheduler (preferably implemented in hardware) may distribute finely granular applications and/or application parts (threads) among resources within the processor. The VPU data path may be regarded as a resource for the scheduler. A clean separation of the CPU data path and the VPU data path may have already been given by definition due to the implementation of multithreading and/or hyperthreading technologies in the compiler. In addition, an advantage may be that when the VPU resource is occupied, it may be possible to simply change within one task to another task and thus achieve better utilization of resources. At the same time, parallel utilization of the CPU data path and VPU data path may also be facilitated.

To this extent, multithreading and/or hyperthreading may constitute a method which may be preferred in comparison with the LINKLIST described above.

The two methods may operate in a particularly efficient manner with regard to performance, e.g., if an architecture that allows reconfiguration superimposed with data processing is used as the VPU, e.g., the wave reconfiguration according to DE 198 07 872, DE 199 26 538, DE 100 28 397.

It is may thus be possible to start a new data processing run and any reconfiguration associated with it immediately after reading the last operands out of the data sources. In other words, for synchronization, reading of the last operands may be required, e.g., instead of the end of data processing. This may greatly increase the performance of data processing.

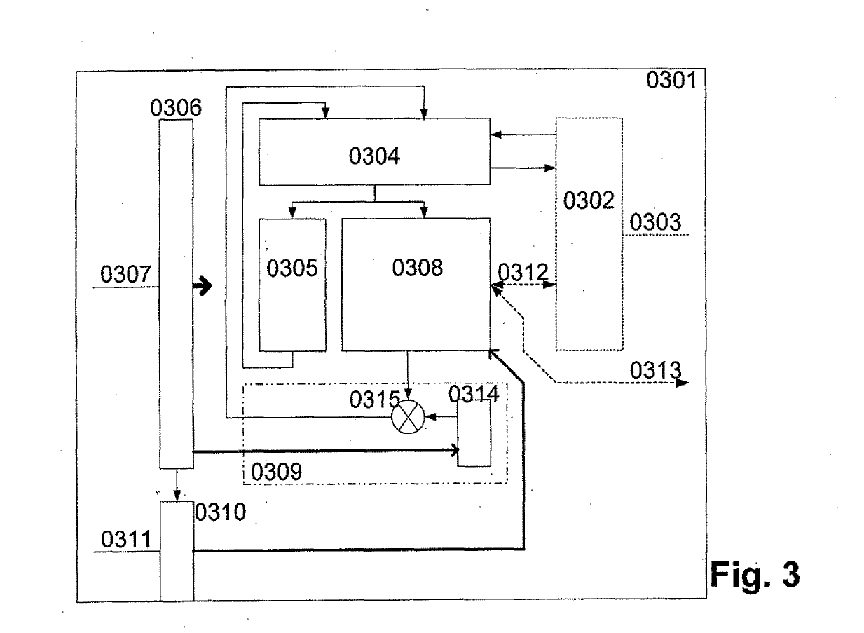

FIG. 3 shows a possible internal structure of a microprocessor or microcontroller. This shows the core (0301) of a microcontroller or microprocessor. The exemplary structure also includes a load/store unit for transferring data between the core and the external memory and/or the peripherals. The transfer may take place via interface 0303 to which additional units such as MMUs, caches, etc. may be connected.

In a processor architecture according to the related art, the load/store unit may transfer the data to or from a register set (0304) which may then store the data temporarily for further internal processing. Further internal processing may take place on one or more data paths, which may be designed identically or differently (0305). There may also be in particular multiple register sets, which may in turn be coupled to different data paths, if necessary (e.g., integer data paths, floating-point data paths, DSP data paths/multiply-accumulate units).

Data paths may take operands from the register unit and write the results back to the register unit after data processing. An instruction loading unit (opcode fetcher, 0306) assigned to the core (or contained in the core) may load the program code instructions from the program memory, translate them and then trigger the necessary work steps within the core. The instructions may be retrieved via an interface (0307) to a code memory with MMUs, caches, etc., connected in between, if necessary.

The VPU data path (0308) parallel to data path 0305 may have reading access to register set 0304 and may have writing access to the data register allocation unit (0309) described below. A construction of a VPU data path is described, for example, in DE 196 51 075, DE 100 50 442, DE 102 06 653 filed by the present applicant and in several publications by the present applicant.

The VPU data path may be configured via the configuration manager (CT) 0310 which may load the configurations from an external memory via a bus 0311. Bus 0311 may be identical to 0307, and one or more caches may be connected between 0311 and 0307 and/or the memory, depending on the design.

The configuration that is to be configured and executed at a certain point in time may be defined by opcode fetcher 0306 using special opcodes. Therefore, a number of possible configurations may be allocated to a number of opcodes reserved for the VPU data path. The allocation may be performed via a reprogrammable lookup table (see 0106) upstream from 0310 so that the allocation may be freely programmable and may be variable within the application.

In one example embodiment, which may be implemented depending on the application, the destination register of the data computation may be managed in the data register allocation unit (0309) on calling a VPU data path configuration. The destination register defined by the opcode may be therefore loaded into a memory, i.e., register (0314), which may be designed as a FIFO—in order to allow multiple VPU data path calls in direct succession and without taking into account the processing time of the particular configuration. As soon as one configuration supplies the result data, it may be linked (0315) to the particular allocated register address and the corresponding register may be selected and written to 0304.

A plurality of VPU data path calls may thus be performed in direct succession and, for example, with overlap. It may be required to ensure, e.g., by compiler or hardware, that the operands and result data are re-sorted with respect to the data processing in data path 0305, so that there is no interference due to different runtimes in 0305 and 0308.

If the memory and/or FIFO 0314 is full, processing of any new configuration for 0308 may be delayed. Reasonably, 0314 may hold as much register data as 0308 is able to hold configurations in a stack (see DE 197 04 728, DE 100 28 397, DE 102 12 621). In addition to management by the compiler, the data accesses to register set 0304 may also be controlled via memory 0314.

If there is an access to a register that is entered into 0314, it may be delayed until the register has been written and its address has been removed from 0314.

Alternatively, the simple synchronization methods according to 0103 may be used, a synchronous data reception register optionally being provided in register set 0304; for reading access to this data reception register, it may be required that VPU data path 0308 has previously written new data to the register. Conversely, to write data by the VPU data path, it may be required that the previous data has been read. To this extent, 0309 may be omitted without replacement.

When a VPU data path configuration that has already been configured is called, it may be that there is no longer any reconfiguration. Data may be transferred immediately from register set 0304 to the VPU data path for processing and may then be processed. The configuration manager may save the configuration code number currently loaded in a register and compare it with the configuration code number that is to be loaded and that is transferred to 0310 via a lookup table (see 0106), for example. It may be that the called configuration may be reconfigured upon a condition that the numbers do not match.

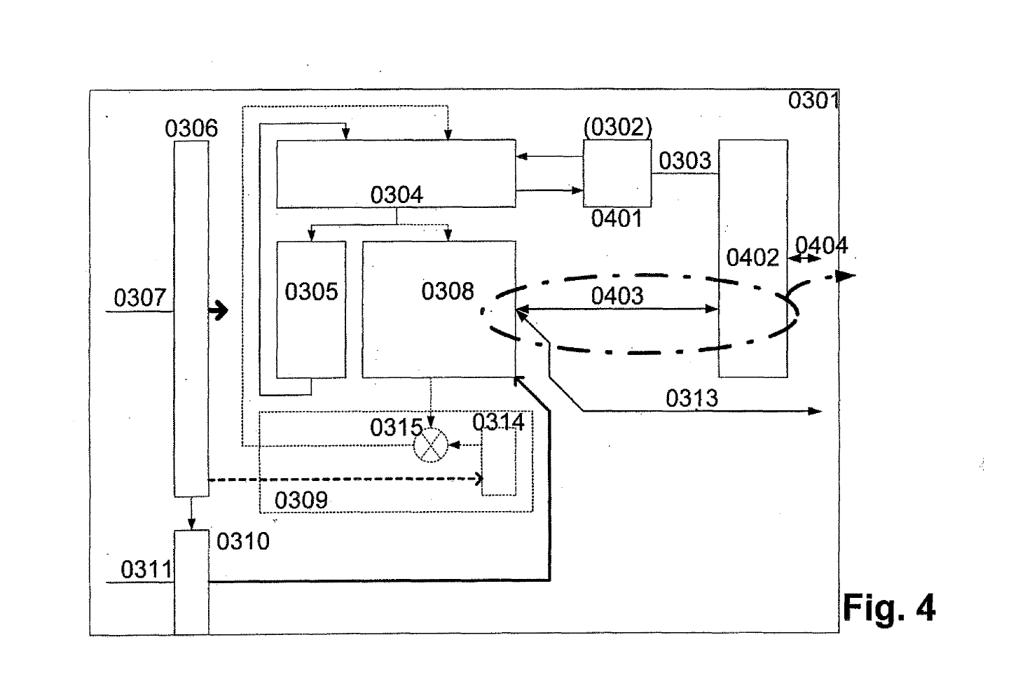

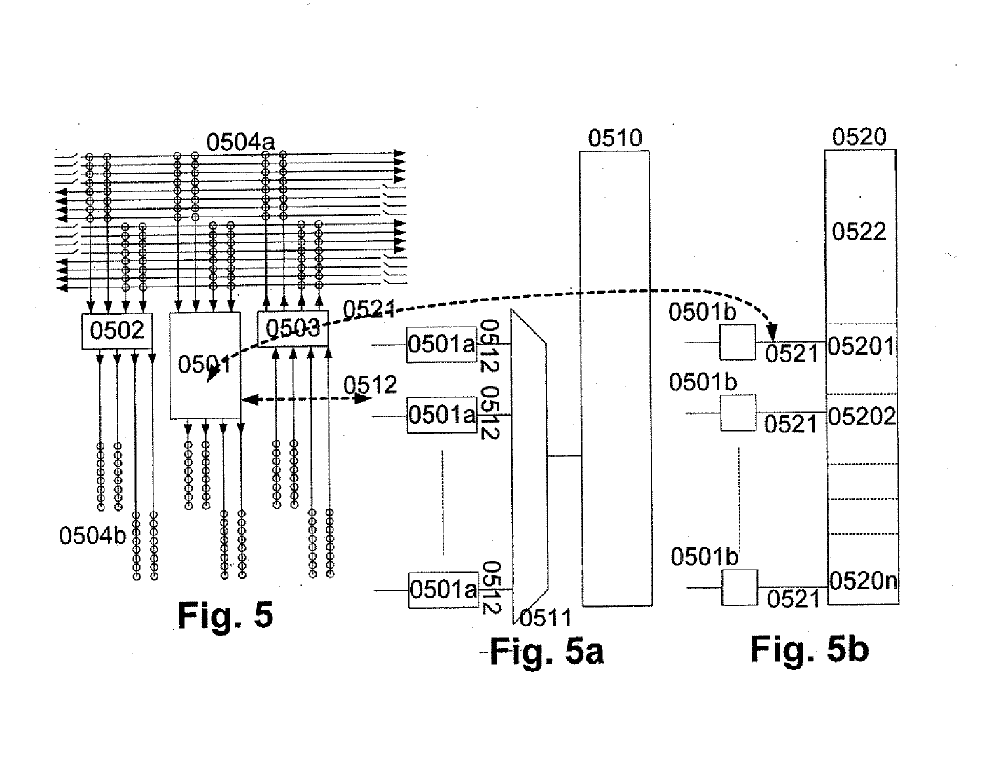

The load/store unit is depicted only schematically and fundamentally in FIG. 3; one particular embodiment is shown in detail in FIGS. 4 and 5. The VPU data path (0308) may be able to transfer data directly with the load/store unit and/or the cache via a bus system 0312; data may be transferred directly between the VPU data path (0308) and peripherals and/or the external memory via another possible data path 0313, depending on the application.

FIG. 4 shows one example embodiment of the load/store unit.

According to a principle of data processing of the VPU architecture, coupled memory blocks which function more or less as a set of registers for data blocks may be provided on the array of ALU-PAEs. This method is known from DE 196 54 846, DE 101 39 170, DE 199 26 538, DE 102 06 653. As discussed below, it may be desirable here to process LOAD and STORE instructions as a configuration within the VPU, which may make interlinking of the VPU with the load/store unit (0401) of the CPU superfluous. In other words, the VPU may generate its read and write accesses itself, so a direct connection (0404) to the external memory and/or main memory may be appropriate. This may be accomplished, e.g., via a cache (0402), which may be the same as the data cache of the processor. The load/store unit of the processor (0401) may access the cache directly and in parallel with the VPU (0403) without having a data path for the VPU—in contrast with 0302.

FIG. 5 shows particular example couplings of the VPU to the external memory and/or main memory via a cache.

A method of connection may be via an IO terminal of the VPU, as is described, for example, in DE 196 51 075.9-53, DE 196 54 595.1-53, DE 100 50 442.6, DE 102 06 653.1; addresses and data may be transferred between the peripherals and/or memory and the VPU by way of this IO terminal. However, direct coupling between the RAM-PAEs and the cache may be particularly efficient, as described in DE 196 54 595 and DE 199 26 538. An example given for a reconfigurable data processing element is a PAE constructed from a main data processing unit (0501) which is typically designed as an ALU, RAM, FPGA, IO terminal and two lateral data transfer units (0502, 0503) which in turn may have an ALU structure and/or a register structure. In addition, the array-internal horizontal bus systems 0504a and 0504b belonging to the PAE are also shown.

In FIG. 5a, RAM-PAEs (0501a) which each may have its own memory according to DE 196 54 595 and DE 199 26 538 may be coupled to a cache 0510 via a multiplexer 0511. Cache controllers and the connecting bus of the cache to the main memory are not shown. The RAM-PAEs may have in one example embodiment a separate databus (0512) having its own address generators (see also DE 102 06 653) in order to be able to transfer data independently to the cache.

FIG. 5b shows one example embodiment in which 0501b does not denote full-quality RAM-PAEs but instead includes only the bus systems and lateral data transfer units (0502, 0503). Instead of the integrated memory in 0501, only one bus connection (0521) to cache 0520 may be implemented. The cache may be subdivided into multiple segments 05201, 05202 . . . 0520n, each being assigned to a 0501b and, in one embodiment, reserved exclusively for this 0501b. The cache thus more or less may represent the quantity of all RAM-PAEs of the VPU and the data cache (0522) of the CPU.

The VPU may write its internal (register) data directly into the cache and/or read the data directly out of the cache. Modified data may be labeled as “dirty,” whereupon the cache controller (not shown here) may automatically update this in the main memory. Write-through methods in which modified data is written directly to the main memory and management of the “dirty data” becomes superfluous are available as an alternative.

Direct coupling according to FIG. 5b may be desirable because it may be extremely efficient in terms of area and may be easy to handle through the VPU because the cache controllers may be automatically responsible for the data transfer between the cache—and thus the RAM-PAE—and the main memory.

FIG. 6 shows a coupling of an FPGA structure to a data path considering the example of the VPU architecture.

The main data path of a PAE may be 0501. FPGA structures may be inserted (0611) directly downstream from the input registers (see PACT02, PACT22) and/or inserted (0612) directly upstream from the output of the data path to the bus system.

One possible FPGA structure is shown in 0610, the structure being based on PACT13, FIG. 35.

The FPGA structure may be input into the ALU via a data input (0605) and a data output (0606). In alternation
a) logic elements may be arranged in a row (0601) to perform bit-by-bit logic operations (AND, OR, NOT, XOR, etc.) on incoming data. These logic elements may additionally have local bus connections; registers may likewise be provided for data storage in the logic elements;
b) memory elements may be arranged in a row (0602) to store data of the logic elements bit by bit. Their function may be to represent as needed the chronological uncoupling—i.e., the cyclical behavior—of a sequential program if so required by the compiler. In other words, through these register stages the sequential performance of a program in the form of a pipeline may be simulated within 0610.

Horizontal configurable signal networks may be provided between elements 0601 and 0602 and may be constructed according to the known FPGA networks. These may allow horizontal interconnection and transmission of signals.

In addition, a vertical network (0604) may be provided for signal transmission; it may also be constructed like the known FPGA networks. Signals may also be transmitted past multiple rows of elements 0601 and 0602 via this network.

Since elements 0601 and 0602 typically already have a number of vertical bypass signal networks, 0604 is only optional and may be necessary for a large number of rows.

For coordinating the state machine of the PAE to the particular configured depth of the pipeline in 0610, i.e., the number (NRL) of register stages (0602) configured into it between the input (0605) and the output (0606), a register 0607 may be implemented into which NRL may be configured. On the basis of this data, the state machine may coordinate the generation of the PAE-internal control cycles and may also coordinate the handshake signals (PACT02 PACT16, PACT18) for the PAE-external bus systems.

Additional possible FPGA structures are known from Xilinx and Altera, for example. In an embodiment of the present invention, these may have a register structure according to 0610.

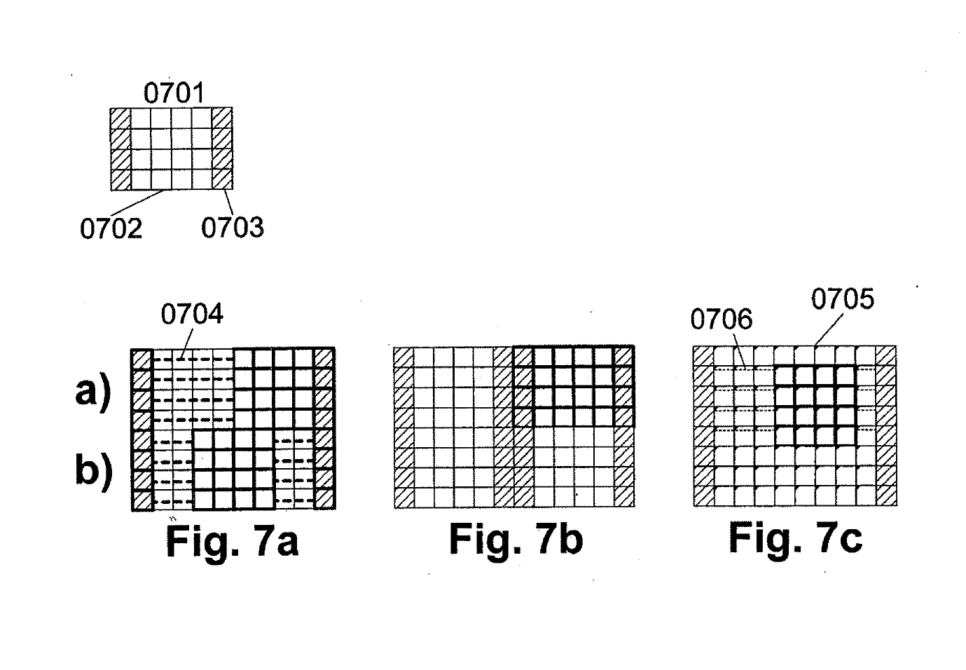

FIG. 7 shows several strategies for achieving code compatibility between VPUs of different sizes:
0701 is an ALU-PAE(0702) RAM-PAE(0703) device which may define a possible “small” VPU. It is assumed in the following discussion that code has been generated for this structure and is now to be processed on other larger VPUs.

In a first possible embodiment, new code may be compiled for the new destination VPU. This may offer an advantage in that functions no longer present may be simulated in a new destination VPU by having the compiler instantiate macros for these functions which then simulate the original function. The simulation may be accomplished, e.g., through the use of multiple PAEs and/or by using sequencers as described below (e.g., for division, floating point, complex mathematics, etc.) and as known from PACT02 for example. However, with this method, binary compatibility may be lost.

The methods illustrated in FIG. 7 may have binary code compatibility.

According to a first method, wrapper code may be inserted (0704), lengthening the bus systems between a small ALU-PAE array and the RAM-PAEs. The code may contain, e.g., only the configuration for the bus systems and may be inserted from a memory into the existing binary code, e.g., at the configuration time and/or at the load time.

However, this method may result in a lengthy information transfer time over the lengthened bus systems. This may be disregarded at comparatively low frequencies (FIG. 7a, a)).

FIG. 7a, b) shows one example embodiment in which the lengthening of the bus systems has been compensated and thus is less critical in terms of frequency, which halves the runtime for the wrapper bus system compared to FIG. 7a, a).

For higher frequencies, the method according to FIG. 7b may be used; in this method, a larger VPU may represent a superset of compatible small VPUs (0701) and the complete structures of 0701 may be replicated. This is a method of providing direct binary compatibility.

In one example method according to FIG. 7c, additional high-speed bus systems may have a terminal (0705) at each PAE or each group of PAEs. Such bus systems are known from other patent applications by the present applicant, e.g., PACT07. Data may be transferred via terminals 0705 to a high-speed bus system (0706) which may then transfer the data in a performance-efficient manner over a great distance. Such high-speed bus systems may include, for example, Ethernet, RapidIO, USB, AMBA, RAMBUS and other industry standards.

The connection to the high-speed bus system may be inserted either through a wrapper, as described for FIG. 7a, or architectonically, as already provided for 0701. In this case, at 0701 the connection may be relayed directly to the adjacent cell and without use thereof. The hardware abstracts the absence of the bus system here.

Reference was made above to the coupling between a processor and a VPU in general and/or even more generally to a unit that is completely and/or partially and/or rapidly reconfigurable in particular at runtime, i.e., completely in a few clock cycles. This coupling may be supported and/or achieved through the use of certain operating methods and/or through the operation of preceding suitable compiling. Suitable compiling may refer, as necessary, to the hardware in existence in the related art and/or improved according to the present invention.

Parallelizing compilers according to the related art generally use special constructs such as semaphores and/or other methods for synchronization. Technology-specific methods are typically used. Known methods, however, are not suitable for combining functionally specified architectures with the particular time characteristic and imperatively specified algorithms. The methods used therefore offer satisfactory approaches only in specific cases.

Compilers for reconfigurable architectures, in particular reconfigurable processors, generally use macros which have been created specifically for the certain reconfigurable hardware, usually using hardware description languages (e.g., Verilog, VHDL, system C) to create the macros. These macros are then called (instantiated) from the program flow by an ordinary high-level language (e.g., C, C++).

Compilers for parallel computers are known, mapping program parts on multiple processors on a coarsely granular structure, usually based on complete functions or threads. In addition, vectorizing compilers are known, converting extensive linear data processing, e.g., computations of large terms, into a vectorized form and thus permitting computation on superscalar processors and vector processors (e.g., Pentium, Cray).

This patent therefore describes a method for automatic mapping of functionally or imperatively formulated computation specifications onto different target technologies, in particular onto ASICs, reconfigurable modules (FPGAs, DPGAs, VPUs, ChessArray, KressArray, Chameleon, etc., hereinafter referred to collectively by the term VPU), sequential processors (CISC-/RISC-CPUs, DSPs, etc., hereinafter referred to collectively by the term CPU) and parallel processor systems (SMP, MMP, etc.).

VPUs are essentially made up of a multidimensional, homogeneous or inhomogeneous, flat or hierarchical array (PA) of cells (PAEs) capable of executing any functions, e.g., logic and/or arithmetic functions (ALU-PAEs) and/or memory functions (RAM-PAEs) and/or network functions. The PAEs may be assigned a load unit (CT) which may determine the function of the PAEs by configuration and reconfiguration, if necessary.

This method is based on an abstract parallel machine model which, in addition to the finite automata, also may integrate imperative problem specifications and permit efficient algorithmic derivation of an implementation on different technologies.

The present invention is a refinement of the compiler technology according to DE 101 39 170.6, which describes in particular the close XPP connection to a processor within its data paths and also describes a compiler particularly suitable for this purpose, which also uses XPP stand-alone systems without snug processor coupling.

At least the following compiler classes are known in the related art: classical compilers, which often generate stack machine code and are suitable for very simple processors that are essentially designed as normal sequencers (see N. Wirth, Compilerbau, Teubner Verlag).

Vectorizing compilers construct largely linear code which is intended to run on special vector computers or highly pipelined processors. These compilers were originally available for vector computers such as CRAY. Modern processors such as Pentium require similar methods because of the long pipeline structure. Since the individual computation steps proceed in a vectorized (pipelined) manner, the code is therefore much more efficient. However, the conditional jump causes problems for the pipeline. Therefore, a jump prediction which assumes a jump destination may be advisable. If the assumption is false, however, the entire processing pipeline must be deleted. In other words, each jump is problematical for these compilers and there is no parallel processing in the true sense. Jump predictions and similar mechanisms require a considerable additional complexity in terms of hardware.

Coarsely granular parallel compilers hardly exist in the true sense; the parallelism is typically marked and managed by the programmer or the operating system, e.g., usually on the thread level in the case of MMP computer systems such as various IBM architectures, ASCII Red, etc. A thread is a largely independent program block or an entirely different program. Threads are therefore easy to parallelize on a coarsely granular level. Synchronization and data consistency must be ensured by the programmer and/or operating system. This is complex to program and requires a significant portion of the computation performance of a parallel computer. Furthermore, only a fraction of the parallelism that is actually possible is in fact usable through this coarse parallelization.

Finely granular parallel compilers (e.g., VLIW) attempt to map the parallelism on a finely granular level into VLIW arithmetic units which are able to execute multiple computation operations in parallel in one clock pulse but have a common register set. This limited register set presents a significant problem because it must provide the data for all computation operations. Furthermore, data dependencies and inconsistent read/write operations (LOAD/STORE) make parallelization difficult.

Reconfigurable processors have a large number of independent arithmetic units which are not interconnected by a common register set but instead via buses. Therefore, it is easy to construct vector arithmetic units while parallel operations may also be performed easily. Contrary to traditional register concepts, data dependencies are resolved by the bus connections.

With respect to embodiments of the present invention, it has been recognized that the concepts of vectorizing compilers and parallelizing compilers (e.g., VLIW) are to be applied simultaneously for a compiler for reconfigurable processors and thus they are to be vectorized and parallelized on a finely granular level.

An advantage may be that the compiler need not map onto a fixedly predetermined hardware structure but instead the hardware structure may be configured in such a way that it may be optimally suitable for mapping the particular compiled algorithm.

### Description of the Compiler and Data Processing Device Operating Methods According to Embodiments of the Present Invention

Modern processors usually have a set of user-definable instructions (UDI) which are available for hardware expansions and/or special coprocessors and accelerators. If UDIs are not available, processors usually at least have free instructions which have not yet been used and/or special instructions for coprocessors—for the sake of simplicity, all these instructions are referred to collectively below under the heading UDIs.

A quantity of these UDIs may now be used according to one embodiment of the present invention to trigger a VPU that has been coupled to the processor as a data path. For example, UDIs may trigger the loading and/or deletion and/or initialization of configurations and specifically a certain UDI may refer to a constant and/or variable configuration.

Configurations may be preloaded into a configuration cache which may be assigned locally to the VPU and/or preloaded into configuration stacks according to DE 196 51 075.9-53, DE 197 04 728.9 and DE 102 12 621.6-53 from which they may be configured rapidly and executed at runtime on occurrence of a UDI that initializes a configuration. Preloading the configuration may be performed in a configuration manager shared by multiple PAEs or PAs and/or in a local configuration memory on and/or in a PAE, in which case it may be required for only the activation to be triggered.

A set of configurations may be preloaded. In general, one configuration may correspond to a load UDI. In other words, the load UDIs may be each referenced to a configuration. At the same time, it may also be possible with a load UDI to refer to a complex configuration arrangement with which very extensive functions that may require multiple reloading of the array during execution, a wave reconfiguration, and/or even a repeated wave reconfiguration, etc., referenceable by an individual UDI.

During operation, configurations may also be replaced by others and the load UDIs may be re-referenced accordingly. A certain load UDI may thus reference a first configuration at a first point in time and at a second point in time it may reference a second configuration that has been newly loaded in the meantime. This may occur by the fact that an entry in a reference list which is to be accessed according to the UDI is altered.

Within the scope of the present invention, a LOAD/STORE machine model, such as that known from RISC processors, for example, may be used as the basis for operation of the VPU. Each configuration may be understood to be one instruction. The LOAD and STORE configurations may be separate from the data processing configurations.

A data processing sequence (LOAD-PROCESS-STORE) may thus take place as follows, for example:

### 1. LOAD Configuration

Loading the data from an external memory, for example, a ROM of an SOC into which the entire arrangement may be integrated and/or from peripherals into the internal memory bank (RAM-PAE, see DE 196 54 846.2-53, DE 100 50 442.6). The configuration may include, for example if necessary, address generators and/or access controls to read data out of processor-external memories and/or peripherals and enter it into the RAM-PAEs. The RAM-PAEs may be understood as multidimensional data registers (e.g., vector registers) for operation.

2.—(n−1) Data Processing Configurations

The data processing configurations may be configured sequentially into the PA. The data processing may take place exclusively between the RAM-PAEs—which may be used as multidimensional data registers—according to a LOAD/STORE (RISC) processor.

### STORE Configuration

Writing the data from the internal memory banks (RAM-PAEs) to the external memory and/or to the peripherals. The configuration may include address generators and/or access controls to write data from the RAM-PAEs to the processor-external memories and/or peripherals.

Reference is made to PACT11 for the principles of LOAD/STORE operations.

The address generating functions of the LOAD/STORE configurations may be optimized so that, for example, in the case of a nonlinear access sequence of the algorithm to external data, the corresponding address patterns may be generated by the configurations. The analysis of the algorithms and the creation of the address generators for LOAD/STORE may be performed by the compiler.

This operating principle may be illustrated easily by the processing of loops. For example, a VPU having 256-entry-deep RAM-PAEs shall be assumed:

### EXAMPLE A

for i :=1 to 10,000
1. LOAD-PROCESS-STORE cycle : load and process 1 . . . 256
2. LOAD-PROCESS-STORE cycle : load and process 257 . . . 512
3. LOAD-PROCESS-STORE cycle : load and process 513 . . . 768

### EXAMPLE B

for i :=1 to 1000
   for j :=1 to 256
1. LOAD-PROCESS-STORE cycle : load and process
   i=1; j=1 . . . 256
2. LOAD-PROCESS-STORE cycle : load and process
   i=2; j=1 . . . 256
3. LOAD-PROCESS-STORE cycle : load and process
   i=3; j=1 . . . 256
. . .

### EXAMPLE C

for i :=1 to 1000
   for j :=1 to 512
1. LOAD-PROCESS-STORE cycle : load and process
   i=1; j=1 . . . 256
2. LOAD-PROCESS-STORE cycle : load and process
   i=1; j=257 . . . 512
3. LOAD-PROCESS-STORE cycle : load and process
   i=2; j=1 . . . 256
. . .

It may be desirable for each configuration to be considered to be atomic, i.e., not interruptable. This may therefore solve the problem of having to save the internal data of the PA and the internal status in the event of an interruption. During execution of a configuration, the particular status may be written to the RAM-PAEs together with the data.

However, with this method, it may be that initially no statement is possible regarding the runtime behavior of a configuration. This may result in disadvantages with respect to the realtime capability and the task change performance.

Therefore, in an embodiment of the present invention, the runtime of each configuration may be limited to a certain maximum number of clock pulses. Any possible disadvantage of this embodiment may be disregarded because typically an upper limit is already set by the size of the RAM-PAEs and the associated data volume. Logically, the size of the RAM-PAEs may correspond to the maximum number of data processing clock pulses of a configuration, so that a typical configuration is limited to a few hundred to one thousand clock pulses. Multithreading/hyperthreading and realtime methods may be implemented together with a VPU by this restriction.

The runtime of configurations may be monitored by a tracking counter and/or watchdog, e.g., a counter (which runs with the clock pulse or some other signal). If the time is exceeded, the watchdog may trigger an interrupt and/or trap which may be understood and treated like an “illegal opcode” trap of processors.

Alternatively, a restriction may be introduced to reduce reconfiguration processes and to increase performance:

Running configurations may retrigger the watchdog and may thus proceed more slowly without having to be changed. A retrigger may be allowed, e.g., only if the algorithm has reached a “safe” state (synchronization point in time) at which all data and states have been written to the RAM-PAEs and an interruption is allowed according to the algorithm. A disadvantage of this may be that a configuration could run in a deadlock within the scope of its data processing but may continue to retrigger the watchdog properly and it may be that it thus does not terminate the configuration.

A blockade of the VPU resource by such a zombie configuration may be prevented by the fact that retriggering of the watchdog may be suppressed by a task change and thus the configuration may be changed at the next synchronization point in time or after a predetermined number of synchronization times. Then although the task having the zombie is no longer terminated, the overall system may continue to run properly.

Optionally multithreading and/or hyperthreading may be introduced as an additional method for the machine model and/or the processor. All VPU routines, i.e., their configurations, are preferably considered then as a separate thread. With a coupling to the processor of the VPU as the arithmetic unit, the VPU may be considered as a resource for the threads. The scheduler implemented for multithreading according to the related art (see also P 42 21 278.2-09) may automatically distribute threads programmed for VPUs (VPU threads) to them. In other words, the scheduler may automatically distribute the different tasks within the processor.

This may result in another level of parallelism. Both pure processor threads and VPU threads may be processed in parallel and may be managed automatically by the scheduler without any particular additional measures.

This method may be particularly efficient when the compiler breaks down programs into multiple threads that are processable in parallel, as is usually possible, thereby dividing all VPU program sections into individual VPU threads.

To support a rapid task change, in particular including realtime systems, multiple VPU data paths, each of which is considered as its own independent resource, may be implemented. At the same time, this may also increase the degree of parallelism because multiple VPU data paths may be used in parallel.

To support realtime systems in particular, certain VPU resources may be reserved for interrupt routines so that for a response to an incoming interrupt it is not necessary to wait for termination of the atomic non-interruptable configurations. Alternatively, VPU resources may be blocked for interrupt routines, i.e., no interrupt routine is able to use a VPU resource and/or contain a corresponding thread. Thus rapid interrupt response times may be also ensured. Since typically no VPU-performing algorithms occur within interrupt routines, or only very few, this method may be desirable. If the interrupt results in a task change, the VPU resource may be terminated in the meantime. Sufficient time is usually available within the context of the task change.

One problem occurring in task changes may be that it may be required for the LOAD-PROCESS-STORE cycle described previously to be interrupted without having to write all data and/or status information from the RAM-PAEs to the external RAMS and/or peripherals.

According to ordinary processors (e.g., RISC LOAD/STORE machines), a PUSH configuration is now introduced; it may be inserted between the configurations of the LOAD-PROCESS-STORE cycle, e.g., in a task change. PUSH may save the internal memory contents of the RAM-PAEs to external memories, e.g., to a stack; external here means, for example, external to the PA or a PA part but it may also refer to peripherals, etc. To this extent PUSH may thus correspond to the method of traditional processors in its principles. After execution of the PUSH operation, the task may be changed, i.e., the instantaneous LOAD-PROCESS-STORE cycle may be terminated and a LOAD-PROCESS-STORE cycle of the next task may be executed. The terminated LOAD-PROCESS-STORE cycle may be incremented again after a subsequent task change to the corresponding task in the configuration (KATS) which may follow after the last configuration implemented. To do so, a POP configuration may be implemented before the KATS configuration and thus the POP configuration in turn may load the data for the RAM-PAEs from the external memories, e.g., the stack, according to the methods used with known processors.

An expanded version of the RAM-PAEs according to DE 196 54 595.1-53 and DE 199 26 538.0 may be particularly efficient for this purpose; in this version the RAM-PAEs may have direct access to a cache (DE 199 26 538.0) (case A) or may be regarded as special slices within a cache and/or may be cached directly (DE 196 54 595.1-53) (case B).

Due to the direct access of the RAM-PAEs to a cache or direct implementation of the RAM-PAEs in a cache, the memory contents may be exchanged rapidly and easily in a task change.

Case A: the RAM-PAE contents may be written to the cache and loaded again out of it, e.g., via a separate and independent bus. A cache controller according to the related art may be responsible for managing the cache. Only the RAM-PAEs that have been modified in comparison with the original content need be written into the cache. A “dirty” flag for the RAM-PAEs may be inserted here, indicating whether a RAM-PAE has been written and modified. It should be pointed out that corresponding hardware means may be provided for implementation here.

Case B: the RAM-PAEs may be directly in the cache and may be labeled there as special memory locations which are not affected by the normal data transfers between processor and memory. In a task change, other cache sections may be referenced. Modified RAM-PAEs may be labeled as dirty. Management of the cache may be handled by the cache controller.

In application of cases A and/or B, a write-through method may yield considerable advantages in terms of speed, depending on the application. The data of the RAM-PAEs and/or caches may be written through directly to the external memory with each write access by the VPU. Thus the RAM-PAE and/or the cache content may remain clean at any point in time with regard to the external memory (and/or cache). This may eliminate the need for updating the RAM-PAEs with respect to the cache and/or the cache with respect to the external memory with each task change.

PUSH and POP configurations may be omitted when using such methods because the data transfers for the context switches are executed by the hardware.

By restricting the runtime of configurations and supporting rapid task changes, the realtime capability of a VPU-supported processor may be ensured.

The LOAD-PROCESS-STORE cycle may allow a particularly efficient method for debugging the program code according to DE 101 42 904.5. If each configuration is considered to be atomic and thus uninterruptible, then the data and/or states relevant for debugging may be essentially in the RAM-PAEs after the end of processing of a configuration. It may thus only be required that the debugger access the RAM-PAEs to obtain all the essential data and/or states.

Thus the granularity of a configuration may be adequately debuggable. If details regarding the process configurations must be debugged, according to DE 101 42 904.5 a mixed mode debugger is used with which the RAM-PAE contents are read before and after a configuration and the configuration itself is checked by a simulator which simulates processing of the configuration.

If the simulation results do not match the memory contents of the RAM-PAEs after the processing of the configuration processed on the VPU, then the simulator might not be consistent with the hardware and there may be either a hardware defect or a simulator error which must then be checked by the manufacturer of the hardware and/or the simulation software.

It should be pointed out in particular that the limitation of the runtime of a configuration to the maximum number of cycles may promote the use of mixed-mode debuggers because then only a relatively small number of cycles need be simulated.

Due to the method of atomic configurations described here, the setting of breakpoints may be simplified because monitoring of data after the occurrence of a breakpoint condition is necessary only on the RAM-PAEs, so that it may be that only they need be equipped with breakpoint registers and comparators.

In an example embodiment of hardware according to the present invention, the PAEs may have sequencers according to

DE 196 51 075.9-53 (FIGS. 17, 18, 21) and/or DE 199 26 538.0, with entries into the configuration stack (see DE 197 04 728.9, DE 100 28 397.7, DE 102 12 621.6-53) being used as code memories for a sequencer, for example.

It has been recognized that such sequencers are usually very difficult for compilers to control and use. Therefore, it may be desirable for pseudocodes to be made available for these sequencers with compiler-generated assembler instructions being mapped on them. For example, it may be inefficient to provide opcodes for division, roots, exponents, geometric operations, complex mathematics, floating point instructions, etc. in the hardware. Therefore, such instructions may be implemented as multicyclic sequencer routines, with the compiler instantiating such macros by the assembler as needed.

Sequencers are particularly interesting, for example, for applications in which matrix computations must be performed frequently. In these cases, complete matrix operations such as a 2×2 matrix multiplication may be compiled as macros and made available for the sequencers.

If in an example embodiment of the architecture, FPGA units are implemented in the ALU-PAEs, then the compiler may have the following option:

When logic operations occur within the program to be translated by the compiler, e.g., &, |, >>, <<, etc., the compiler may generate a logic function corresponding to the operation for the FPGA units within the ALU-PAE. To this extent the compiler may be able to ascertain that the function does not have any time dependencies with respect to its input and output data, and the insertion of register stages after the function may be omitted.

If a time independence is not definitely ascertainable, then registers may be configured into the FPGA unit according to the function, resulting in a delay by one clock pulse and thus triggering the synchronization.

On insertion of registers, the number of inserted register stages per FPGA unit on configuration of the generated configuration on the VPU may be written into a delay register which may trigger the state machine of the PAE. The state machine may therefore adapt the management of the handshake protocols to the additionally occurring pipeline stage.

After a reset or a reconfiguration signal (e.g., Reconfig) (see PACT08, PACT16) the FPGA units may be switched to neutral, i.e., they may allow the input data to pass through to the output without modification. Thus, it may be that configuration information is not required for unused FPGA units.

All the PACT patent applications cited here are herewith incorporated fully for disclosure purposes.

Any other embodiments and combinations of the inventions referenced here are possible and will be obvious to those skilled in the art, and those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1-20. (canceled)

21. A processor device comprising:
a sequential data processing unit;
a plurality of data storage elements;
an array of data processing elements connected to the plurality of data storage elements; and
a data cache shared by the sequential data processing unit and the array of data processing elements;
wherein:
the data cache is divided into memory segments;
each of the plurality of data storage elements corresponds to a respective one of the memory segment; and
the processor device is adapted for at least some of the plurality of data storage elements to access their respective memory segment simultaneously, each independently of the others of the plurality of data storage elements.

22. The processor device of claim 21, wherein the sequential data processing unit is a central processing unit (CPU).

23. The processor device of claim 21, wherein the sequential data processing unit is adapted for accessing the data cache simultaneously and independently from the array of data processing elements.

24. The processor device of claim 21, wherein the processor device is adapted for the sequential processing unit to be blocked from accessing some regions of the data cache.

25. The processor device of claim 21, wherein the array of data processing elements is part of a runtime reconfigurable processor.

26. A processor device comprising:
a sequential data processing unit;
an arrangement of data processing elements having vector registers; and
a data cache shared by the sequential data processing unit and the arrangement of data processing elements;
wherein:
the vector registers are directly connected to the data cache; and
the data cache is simultaneously and independently accessible by the sequential data processing unit and the arrangement of data processing elements.

27. The processor device of claim 26, wherein the sequential data processing unit is a central processing unit (CPU).

28. The processor device of claim 26, wherein the processor device is adapted for the sequential processing unit to be blocked from accessing some regions of the data cache.

29. The processor device of claim 26, wherein the vector registers are implemented as a cache segment.

30. The processor device of claim 26, further comprising:
an arrangement for bypassing the cache for direct data transfers between the vector registers and memory.

31. A processor device comprising:
a sequential data processing unit having a register set; and
an arrangement of data processing elements;
an unit adapted for:
in a data transfer defined by an opcode, transferring operand and result data between the register file and the arrangement of data processing elements; and
sorting at least one of the operand and result data so that there is no interference due to different runtimes.

32. The processor device of claim 31, wherein the sequential data processing unit is a central processing unit (CPU).

33. The processor device of claim 31, wherein the arrangement of data processing elements is part of a runtime reconfigurable processor.

34. The processor device of claim 31, wherein the arrangement of data processing elements has vector registers.

35. A processor device having:
a sequential data processing unit having a register set; and
an arrangement of data processing elements;
a register allocation unit for managing destination registers for data processing results, using opcodes that identify the destination registers.

36. The processor device of claim 35, wherein the sequential data processing unit is a central processing unit (CPU).

37. The processor device of claim 35, wherein the arrangement of data processing elements is part of a runtime reconfigurable processor.

38. The processor device of claim 35, wherein the arrangement of data processing elements has vector registers.
